(19) United States
(12) Patent Application Publication
(10) Pub. No.: US 2010/0122044 A1
(43) Pub. Date: May 13, 2010

(54) Data dependency scoreboarding

(76) Inventors: Simon Ford, Cambridgeshire (GB); Dominic Hugo Symes, Cambridgeshire (GB); Alastair Reid, Cambridgeshire (GB)

Correspondence Address: NIXON & VANDERHYE P.C., 901 N. Glebe Road, 11th Floor, Arlington, VA, 22203-1808, US

(21) Appl. No.: 12/308,405

(22) PCT Filed: Jul. 11, 2006
(86) PCT No.: PCT/GB2006/002555

§ 371 Date: Dec. 15, 2008

(51) Int. Cl. G06F 9/38; G06F 15/80; G06F 12/00

(52) U.S. Cl. 711/154; 345/505; 712/217; 711/E12.001; 712/E09.045

(57) ABSTRACT

A parallel processing technique is described for performing parallel processing operations upon N-dimensional arrays of data elements for which a corresponding N-dimensional Scoreboard of status data is held. Hazard checking for data dependencies upon data elements within the N-dimensional array of data elements is performed by looking up the corresponding status value within the Scoreboard. The status data for a given data element within the Scoreboard is located at a position which can be derived from the position of the data elements within its N-dimensional array. Thus, a two-dimensional array of video macroblocks can have a corresponding two-dimensional Scoreboard of status data indicating whether individual macroblocks have, for example, either already been deblocked or have not already been deblocked.

This invention relates to the field of data processing systems. More particularly, this invention relates to the identification of data hazards due to data dependency during parallel processing using scoreboard techniques.

It is known within the field of microprocessors to provide a scoreboard used in association with a sequence of operations on resources such as a register bank. This helps to prevent data hazards, such as read before write etc.

It is known to split a video decoder into pipelined stages running on separate processing units to provide a degree of parallel processing. The management of data dependencies can be achieved by using a sequence of simple data queues between the stages such that the processing in one stage is not commenced until the necessary processing in the preceding stage has been completed. Whilst this approach is suitable for avoiding data hazards, it has the disadvantage that each pipelined stage is performing a different operation, such as unpacking, initial decoding, deblocking etc, and it does not allow parallel processing to bear upon an individual processing operation.

An example of a pipelined approach to parallel video decoding is described in the paper “H.264 Baseline Video Implementation on the CT3400 Multiprocessor DSP” by Z Lance Wang of Cradle Technologies.

It is also known to split a video image to be decoded into multiple regions with an individual processor then serving to decode each individual region. In order for this type of processing to be efficiently achieved it is necessary for the data stream to match the type of decoding to be performed, such as containing regions that are independently decodable, e.g. slices as used in video decoding. Often there is no such control over the data stream to be decoded.

It is also known to provide a high level parallel coordination language called LINDA that uses a logical associative memory called “tuplespace” which can store tuples, such as (state, x, y). However, it is inefficient to store (x, y) values with each state data item and it is also inefficient to have to search all these tuples to identify whether any indicates a state which would represent a data hazard for a data processing operation to be performed.

Viewed from one aspect the present invention provides a method of processing data, said method comprising the steps of

performing a plurality of parallel processing operations upon an N-dimensional array of data elements, where N is an integer greater than one;

storing within a scoreboard memory status data indicative of a status of respective data elements within said N-dimensional array of data elements, a location of a data element within said N-dimensional array of data elements being indicative of a storage location within said scoreboard memory of status data corresponding to said data element; and

checking for a data hazard, in respect of processing to be performed upon a given data element within said N-dimensional array of data elements arising from a plurality of other data elements within said N-dimensional array of data elements having respective positions-within said N-dimensional array of data elements relative to said given data element and upon which processing for said given data element is dependent, by reading status data for said plurality of other data elements within said N-dimensional array of data elements from said scoreboard memory.

The present technique recognizes that within the context of parallel processing performed upon an N-dimensional array of data elements, it is efficient and advantageous to use a scoreboard memory storing status data for the data elements where the location of the status data for a given data element is indicated by the location of that data element within the N-dimensional array of data elements such that separate location data for the status data need not be stored. Furthermore, the data hazard checking using status data of other data elements can be achieved by knowing their relative position to the given data element to be processed allowing the provision of efficient coding and operation, which is important in achieving high performance. Thus, a memory efficient scoreboarding technique is achieved which is also capable of high performance implementation by deriving the location of the status data within a scoreboard from the location of a data element for which the status data of other data elements is being checked.

The processing may be performed by multithreading on one or more processors, but is particularly suited to systems having a plurality of processors operating in parallel.

The hazard checking could be performed by one or more of these processors themselves, or alternatively by a separate hazard checking processor. This is particularly useful when the parallel processing is being performed by special purpose data engines.

The position data may optionally include some absolute position specifying data as well as being inferred from relative positions of the data elements.

It will be appreciated that the N-dimensional arrays of data elements could be two-dimensional, three-dimensional or some higher order of dimension. However, many real examples of use of the current technique will be in the processing of two-dimensional arrays of data, such as pixel data, which could be, for example, macroblocks of video data or macroblocks of image data.

The status data and data elements could be stored separately or together in some merged form of array.

The scoreboard memory could store the status data in a variety of different ways. One direct way of storing the data is to use a corresponding N-dimensional array of status data. Thus, an individual data element within the N-dimensional array of data elements will map to an individual status data item within the N-dimensional array of status data.

The status data could be a simple binary flag having two possible states, such as processed or not processed. However, in other embodiments, the status data could take three or more different values indicative, for example, of various levels or stages of processing.

The scoreboard memory may also store the status data as a plurality of N-dimensional arrays of status data representing different aspects of the status of a given data element within the N-dimensional array of data elements.

It will be appreciated that the processing of the N-dimensional array of data elements as parallel operations (parallel threads) could be achieved in a variety of different ways depending upon the particular algorithm being used, but a common type of parallel processing that is well suited to the present technique is one in which each processor of the plurality of processors performs processing operations upon a sequence of data elements extending along a processing track, such as a one dimension within the N-dimensional array of data elements with the position in the other dimensions being common between those data elements.

Thus, an individual processor will process a line (row) of data elements in a sequence and then move onto another such line (either adjacent or at some regular spacing therefrom) until the entire processing required upon the N-dimensional data processing array has been performed. The processing workload is thus split in parallel between the different processors, which may all be performing a common processing operation (e.g. all deblocking video data) whilst the data hazards due to data dependencies are managed with reference to the scoreboard memory using its efficient data storage and access mechanisms.

The relationships in position within the N-dimensional array of data elements corresponding to the data hazard dependencies can take a wide variety of different forms, but in many practical uses of the present technique the data dependencies is to neighbouring data elements in respective dimensions within the array as these are most likely to influence a given data element in real life situations.

It will be appreciated that a further refinement in respect of the scoreboard memory is that the scoreboard memory may store only an active window upon the status data such that status data which is being tracked is not stored for a region if for that region the status data is that all processing has been performed or that none of the processing is being performed. This is a common situation and this windowing technique advantageously reduces the amount of memory required for the scoreboard.

Viewed from another aspect the present invention provides an apparatus for processing data to perform a plurality parallel processing operations upon an N-dimensional array of data elements, where N is an integer greater than one, said apparatus comprising:

a scoreboard memory storing status data indicative of a status of respective data elements within said N-dimensional array of data elements, a location of a data element within said N-dimensional array of data elements being indicative of a storage location within said scoreboard memory of status data corresponding to said data element; wherein

at least one of said plurality of processors is arranged to check for a data hazard, in respect of processing to be performed upon a given data element within said N-dimensional array of data elements arising from a plurality of other data elements within said N-dimensional array of data elements having respective positions within said N-dimensional array of data elements relative to said given data element and upon which processing for said given data element is dependent, by reading status data for said plurality of other data elements within said N-dimensional array of data elements from said scoreboard memory.

Viewed from a further aspect the present invention provides an apparatus for processing data to perform a plurality parallel processing operations upon an N-dimensional array of data elements, where N is an integer greater than one, said apparatus comprising:

scoreboard memory means for storing status data indicative of a status of respective data elements within said N-dimensional array of data elements, a location of a data element within said N-dimensional array of data elements being indicative of a storage location of status data corresponding to said data element within said scoreboard memory; wherein

at least one of said plurality of processors means is arranged to check for a data hazard, in respect of processing to be performed upon a given data element within said N-dimensional array of data elements arising from a plurality of other data elements within said N-dimensional array of data elements having respective positions within said N-dimensional array of data elements relative to said given data element and upon which processing for said given data element is dependent, by reading status data for said plurality of other data elements within said N-dimensional array of data elements from said scoreboard memory means.

Embodiments of the invention will now be described, by way of example only, with reference to the accompanying drawings in which:

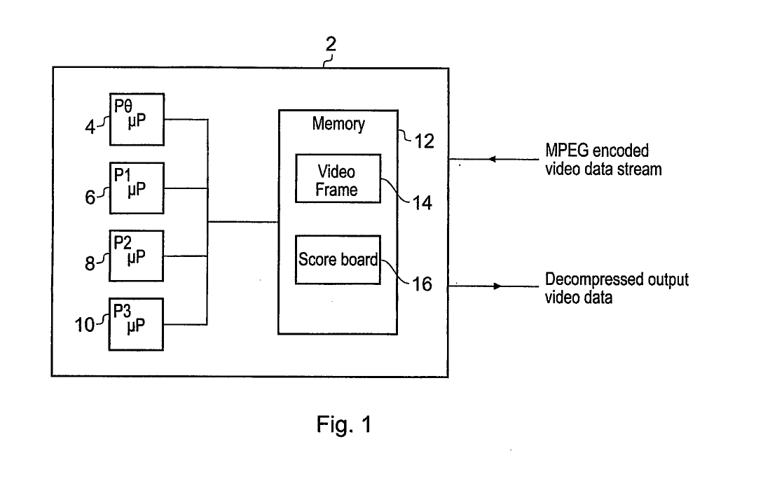

FIG. 1 schematically illustrates a data processing apparatus including multiple processors operating in parallel to decode a video data stream;

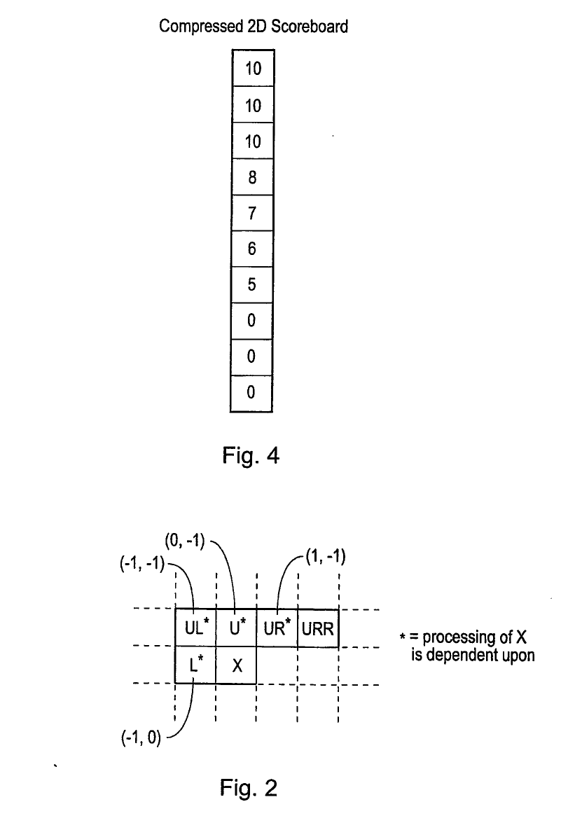

FIG. 2 schematically illustrates data dependencies between video data macroblocks;

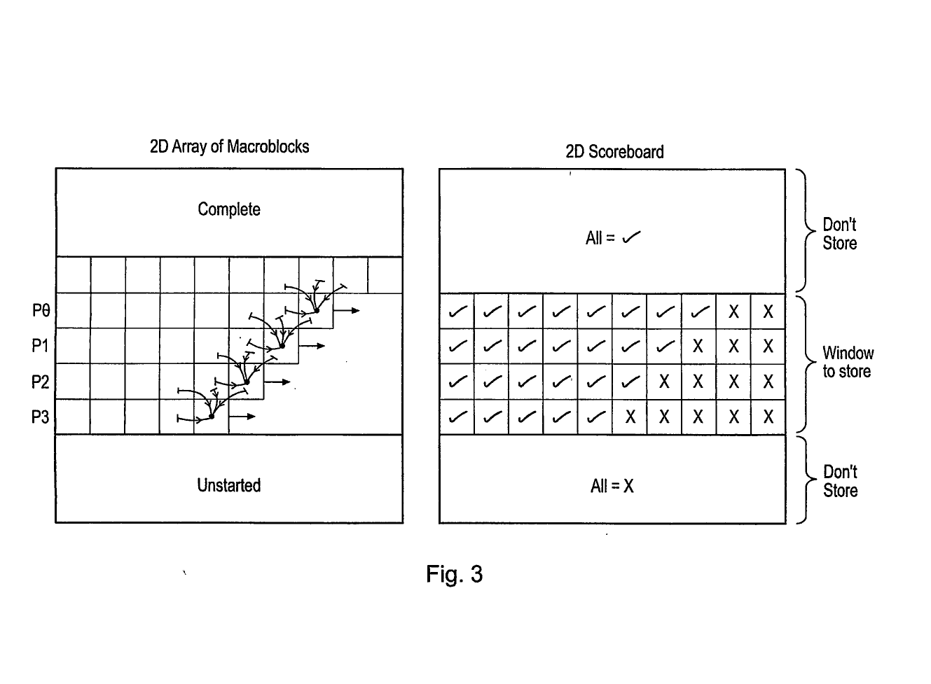

FIG. 3 illustrates a two-dimensional array of macroblocks and a corresponding two-dimensional scoreboard;

FIG. 4 schematically illustrates a compressed version of the two-dimensional scoreboard of FIG. 3;

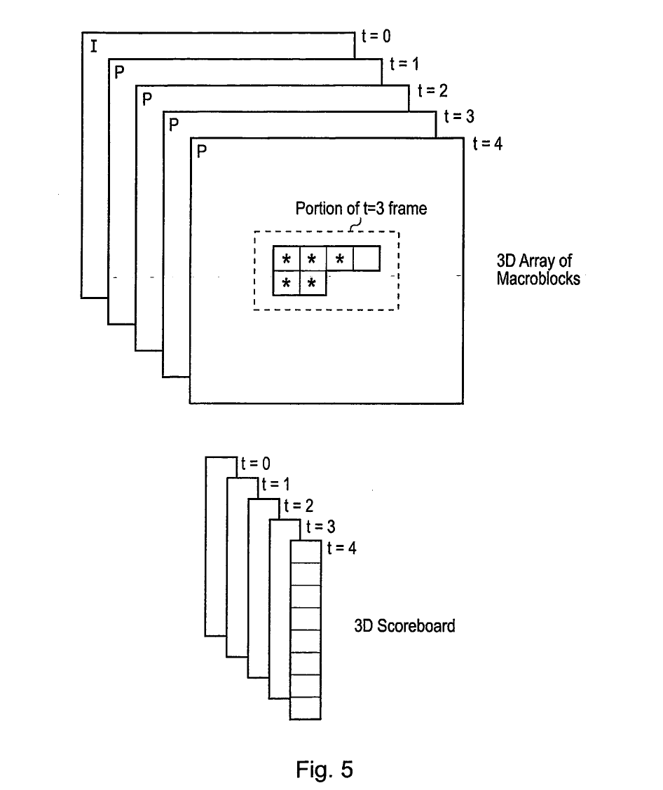

FIG. 5 schematically illustrates a three-dimensional scoreboard using a compressed representation of the status data

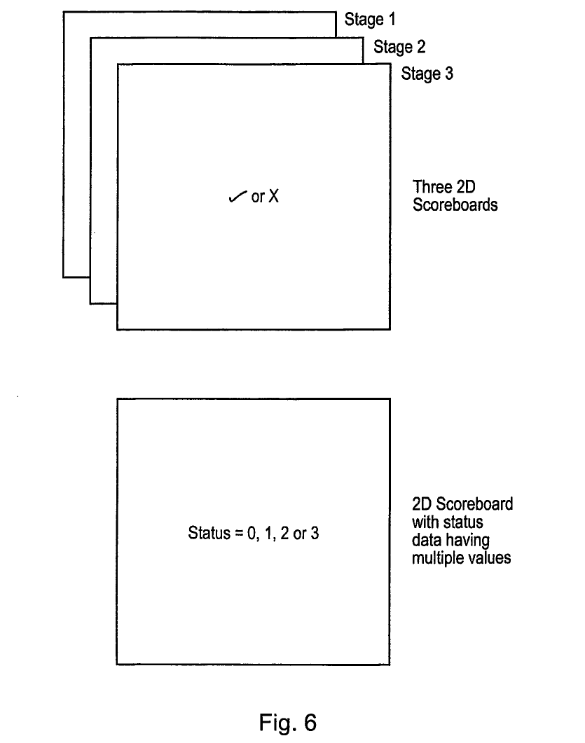

FIG. 6 schematically illustrates the use of multiple scoreboards for a given array of data elements and the use of a single scoreboard in which the status data can have three or more different status values;

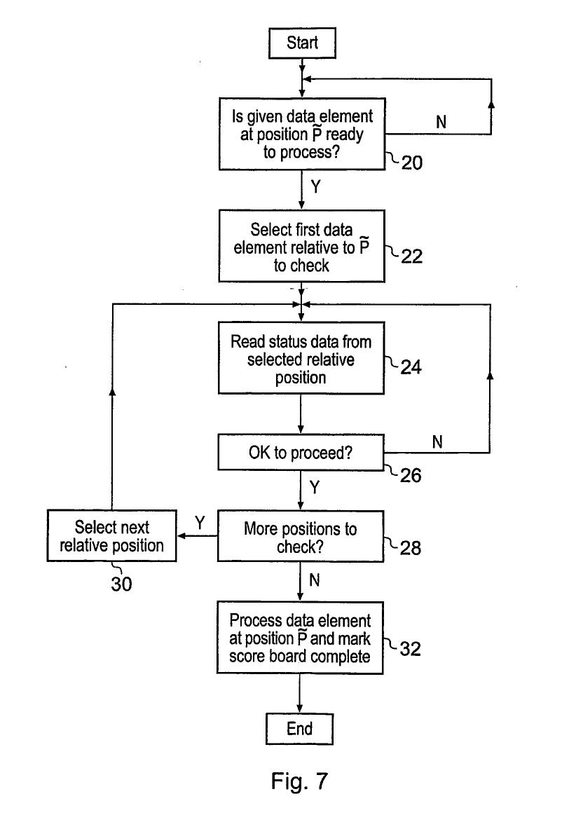

FIG. 7 is a flow diagram schematically illustrating generalised data dependency hazard checking performed by an individual one of a plurality of processors; and

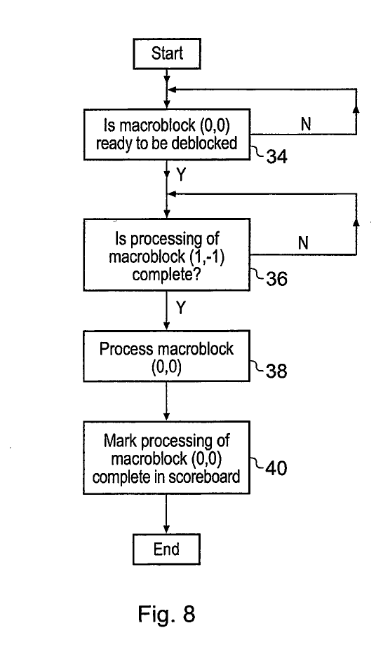

FIG. 8 is a flow diagram schematically illustrating a more specific example of hazard checking.

FIG. 1 illustrates a data processing apparatus 2, such as an integrated circuit (system-on-chip), which incorporates four processors 4, 6, 8, 10. These provide a multiprocessor integrated circuit with each of the processors operating in parallel to perform MPEG video data stream decoding. The processors 4, 6, 8, 10 are shown as sharing a common memory 12. The processors 4, 6, 8, 10 could additionally or alternatively have private memories (not shown). Dividing the processing to be performed between the processors 4, 6, 8, 10 is a significant design decision and it is important that the processing load should be balanced such that no individual processor is standing idle whilst another is unable to perform its required processing load without introducing an undesirable delay. In order to ease load balancing it is desirable that the multiple processors 4, 6, 8, 10 work in parallel to perform a common operation so that no individual processor is unduly burdened or unduly unloaded. With the multiple processors 4, 6, 8, 10 acting upon common tasks in parallel the apparatus of FIG. 1 will more likely be balanced between the multiple processors 4, 6, 8, 10.

As schematically illustrated in FIG. 1, the memory 12 is provided which stores a video frame 14 comprising a two-dimensional array of macroblocks or video data as well as a two-dimensional scoreboard of status data 16. This data could be merged within a common N-dimensional data array. The general purpose memory 12 will include other data as well as the data elements to be processed and the status data as described above.

The processing described above could also be performed by multi-threading on one or more processors. A further example embodiment would use a plurality of data engines each responsible for one processing operation and a separate hazard checking processor for reading the status data and controlling the data engines.

FIG. 2 schematically illustrates the data dependency between neighbouring macroblocks when performing a video deblocking function during MPEG decoding.

Such a deblocking function is one example of a common processing operation which it is desired to share between the multiple processors 4, 6, 8, 10 so that overall processing is achieved more rapidly. As illustrated, an individual processor 4, 6, 8, 10 is attempting to deblock the macroblock X. In accordance with the MPEG 4 Part 10 data compression standard, macroblock X has a data dependency upon four neighbouring macroblocks with respect to its deblocking. These four neighbouring macroblocks are marked with an “s” in FIG. 2 and can respectively be found at the relative coordinate positions of (−1,0),(−1,−1), (0,−1) and (1-1). These neighbouring macroblocks upon which there is a data dependency are also indicated with the labels L left, UL Upper Left, U upper, and UR upper right in FIG. 2. A combination of relatively and absolute addressing may also be used.

FIG. 3 shows the way in which the two-dimensional array of macroblocks to be deblocked is processed by the multiple processors 4, 6, 8, 10 of FIG. 1. Each of the processors performs deblocking upon one row of macroblocks following a processing track. When four such rows have been completed between the multiple processors 4, 6, 8, 10 serving as processors P0 to P3, then the next four rows are processed. In practice, the first processor to complete its row may move onto its next row before the other processors have completed their processing of a row within that block of four rows. As shown in FIG. 3, a portion of the overall video frame will have already been completed in respect of its deblocking. A further portion of the video frame will not yet be started. The active portion of the video frame is shown with the different rows of data elements having been completed to differing extents. The data dependencies for the individual active macroblocks being deblocked are also illustrated in FIG. 3.

Also illustrated in FIG. 3 is the corresponding two-dimensional scoreboards storing status data for the macroblocks. As illustrated, this status data indicates whether a given macroblock has yet been deblocked or has not yet been deblocked. The completed portion of the array of data elements to be processed would correspond within a scoreboard to status data values all indicating that processing has been completed. Similarly, the unstarted region of the two-dimensional array of data elements would correspond to status data indicating unprocessed for all of those areas.

The active area of the scoreboard includes rows of status data values respectively indicating whether an individual corresponding macroblock within the array of data elements either has or has not yet been processed. This status data can then be accessed when checking for a data dependency hazard before commencing deblocking of an individual macroblock by an individual processor.

FIG. 4 illustrates a compressed alternative representation of the two-dimensional scoreboard of FIG. 3. In this representation since it is known that the processing of the macroblocks is conducted in rows from one side to another of the video frame, then the progress of the processing of all the data elements within a row can be represented simply by indicating the last data element that was deblocked within that sequence of data elements of the row to be processed. If it is desired to check whether an individual data-element has or has not been deblocked, then the status data for that row of data elements can be checked and the position of the data element compared with the position of the last data element within that row indicated as having been processed.

FIG. 5 schematically illustrates another example of an array of data elements to be processed. In this example, the array is three-dimensional and comprises a sequence in time of two-dimensional video frames. Three dimensional image data is a further possibility. These individual video frames may be divided into macroblocks as previously discussed with data dependencies between macroblocks within the video frame as illustrated in FIGS. 2 and 3. In addition, there may be a time dependence between frames, such as due to motion compensation or the like, and accordingly if respective frames are to be processed in parallel then it is also important to check that a preceding frame, or at least the relevant portion of that preceding frame (e.g. as determined from a derived motion vector), has completed its necessary processing before it is used in the processing of a subsequent frame. The three-dimensional scoreboard illustrated in FIG. 5 is of the compressed form of FIG. 4 indicating process along a horizontal row of macroblocks, but with multiple such compressed scoreboards being provided, one for each temporal frame.

FIG. 6 schematically illustrates the provision of three separate two-dimensional scoreboards each representing for a two-dimensional array of data elements whether a given stage of processing has or has not been completed. The second example in FIG. 6 is a single two-dimensional scoreboard with the status data within this having four possible status values indicating either that no processing has yet been formed or successively that stages 1, 2 or 3 have been performed, since these are always performed in a fixed sequence.

FIG. 7 is a flow diagram schematically illustrating generalised data dependency hazard checking which may be performed in accordance with the current techniques. This hazard checking is performed by an individual processor, or an individual thread within a multi-threaded system-operating on a single processor.

At step 20 a check is made as to whether a given data element at position \tilde{P} is ready to be processed. In a system in which multiple processing steps are performed and data dependencies may exist therebetween, it is first necessary to check that a given data element has reached the required level of processing in itself to commence the next level of processing.

At step 22 the first data element with a given relative position to the data element P to be processed is selected for checking. At step 24 the status data for the selected relative position is read. At step 26 a determination is made as to whether or not the status data read indicates that the data hazard concerned is or is not present, i.e. is it OK to proceed with processing. If the status data at the relative position concerned indicates that it is not appropriate to proceed, then processing returns to step 24 where the status data is read again until the status data does indicate that processing can proceed.

If the determination at step 26 was that processing could proceed, then step 28 determines whether there are more relative positions to check for the given data element. If there are such further positions, then the next of these is selected at step 30 prior to returning processing to step 24. The plurality of relative positions to be checked can take a wide variety of different forms including relative positions in spatial dimensions, temporal dimensions, colour space or some other dimension of the data to be processed.

If the determination at step 28 was that there were no more relative positions to check, then processing proceeds to step 32 at which the given data element at position \tilde{P} is subject to the processing concerned knowing that the data hazards are not present. The scoreboard for the given data element is then marked to indicate that processing of that data element has completed that particular stage. It shall be noted that an advantageous aspect of this technique is that only a single processor or thread is needed and is able to update the status data for a given data element. This helps simplify the control since the issue of multiple processors or threads competing to update the same status data can be avoided.

FIG. 8 is a flow diagram of a more specific example of data hazard checking in accordance with the techniques described above in relation to FIGS. 1 to 6. At step 34 a determination is made as to whether or not a macroblock at relative position (0, 0) is ready to be deblocked. If the macroblock (0, 0), then step 36 determines whether or not the macroblock at the relative position (1, −1) is ready for processing, i.e. its own processing has completed. This is the macroblock named UR in FIG. 2. It will be appreciated that in the particular example of FIG. 2 if macroblock UR is ready to be processed, then macroblocks U and UL will also be ready since these are processed in sequence prior to the processing of the macroblock UR and accordingly must already have been completed if macroblock UR is ready. The same logic applies to the status of macroblock L since this must be complete if the determination at step 34 is that macroblock X is ready for processing. Thus, it will be seen that steps 34 and 36 effectively check the status data of a plurality of macroblocks at different relative positions to the given macroblock to be processed.

If the determination at step 36 is that the processing of macroblock (1, −1) is complete, then step 38 processes the macroblock (0, 0). At step 40 the status data in respect of macroblock (0, 0) is marked as complete.

1. A method of processing data, said method comprising the steps of performing a plurality of parallel processing operations upon an N-dimensional array of data elements, where N is an integer greater than one;
storing within a scoreboard memory status data indicative of a status of respective data elements within said N-dimensional array of data elements, a location of a data element within said N-dimensional array of data elements being indicative of a storage location within said scoreboard memory of status data corresponding to said data element; and
checking for a data hazard, in respect of processing to be performed upon a given data element within said N-dimensional array of data elements arising from a plurality of other data elements within said N-dimensional array of data elements having respective positions within said N-dimensional array of data elements relative to said given data element and upon which processing for said given data element is dependent, by reading status data for said plurality of other data elements within said N-dimensional array of data elements from said scoreboard memory.

2. A method as claimed in claim 1, wherein said plurality of parallel processing operations are performed by a plurality of processors.

3. A method as claimed in any one of claims 1 and 2, wherein said checking is performed by a separate hazard checking processor.

4. A method as claimed in any one of claims 1, 2 and 3, wherein said respective positions are determined by a combination of an absolute position reference and a position relative to said given data element.

5. A method as claimed in any one of the preceding claims, wherein said N-dimensional array of data elements is a two dimensional array of pixel data.

6. A method as claimed in any one of the preceding claims, wherein said scoreboard memory stores said status data as an N-dimensional array of status data corresponding to said N-dimensional array of data elements.

7. A method as claimed in any one of claims 1 to 5, wherein said status data and said N-dimensional array of data elements are stored together in an N-dimensional data array.

8. A method as claimed in any one of claims 6 and 7, wherein said status data for a data element is indicative of three or more different status values.

9. A method as claimed in any one of claims 1 to 5, wherein said scoreboard memory stores said status data as a plurality of N-dimensional arrays of status data.

10. A method as claimed in claim 2, wherein each processor of said plurality of processors processes said data elements from said N-dimensional array of data elements as sequences of data elements following a processing track through said N-dimensional array of data elements.

11. A method as claimed in claim 10, wherein said processing track extends in one dimension of said N-dimensional array of data elements and has a common position in other dimensions of said N-dimensional array of data elements.

12. A method as claimed in claim 11, wherein said N-dimensional array of data elements is a two-dimensional array of data elements formed as rows and columns and processing of said data elements by a processor of said plurality of processors is performed in turn upon data elements within a row.

13. A method as claimed in any one of claims 11 and 12, wherein different processors of said plurality of processors perform respective processing operations upon different ones of said sequences of data elements extending in one dimension.

14. A method as claimed in any one of claims 10 to 13, wherein said scoreboard memory stores said status data as an indication of a position reached along said processing track in processing of respective ones of said sequences of data elements.

15. A method as claimed in any one of the preceding claims, wherein said plurality of other data elements within said N-dimensional array of data elements having respective predetermined positions within said N-dimensional array of data elements relative to said given data element comprise one or more adjacent data elements within said N-dimensional array of data elements.

16. A method as claimed in any one of the preceding claims, wherein said processing operations performed upon said N-dimensional array of data elements comprises decoding operations and decoding said given data element is dependent upon a result of decoding one or more other data elements within said N-dimensional array of data elements having said predetermined positions within said N-dimensional array of data elements relative to said given data element.

17. A method as claimed in claim 2, wherein said plurality of processors perform a common processing operation in parallel upon different data elements of said N-dimensional array of data elements.

18. A method as claimed in any one of the preceding claims, wherein said data elements are one of
macroblocks of video data;
macroblacks of image data; and
blocks of three dimensional image data.

19. A method as claimed in claim 2, wherein only a respective predetermined one of said plurality of processors is able to write status data corresponding to said given data element.

20. A method as claimed in any one of the preceding claims, wherein said scoreboard memory does not store status data for portions of said N-dimensional array of data elements upon all of which a status change being tracked has been performed or upon none of which said status change being tracked has been performed.

21. Apparatus for processing data to perform a plurality parallel processing operations upon an N-dimensional array of data elements, where N is an integer greater than one, said apparatus comprising:
a scoreboard memory storing status data indicative of a status of respective data elements within said N-dimensional array of data elements, a location of a data element within said N-dimensional array of data elements being indicative of a storage location within said scoreboard memory of status data corresponding to said data element; wherein
at least one of said plurality of processors is arranged to check for a data hazard, in respect of processing to be performed upon a given data element within said N-dimensional array of data elements arising from a plurality of other data elements within said N-dimensional array of data elements having respective positions within said N-dimensional array of data elements relative to said given data element and upon which processing for said given data element is dependent, by reading status data for said plurality of other data elements within said N-dimensional array of data elements from said scoreboard memory.

22. Apparatus as claimed in claim 21, comprising a plurality of processors arranged to perform said plurality of processing operations.

23. Apparatus as claimed in any one of claims 21 and 22, wherein said checking is performed by a separate hazard checking processor.

24. Apparatus as claimed in any one of claims 21, 22 and 23, wherein said respective positions are determined by a combination of an absolute position reference and a position relative to said given data element.

25. Apparatus as claimed in any one of claims 21 to 24, wherein said N-dimensional array of data elements is a two dimensional array of pixel data.

26. Apparatus as claimed in any one of claims 21 to 25, wherein said scoreboard memory stores said status data as an N-dimensional array of status data corresponding to said N-dimensional array of data elements.

27. Apparatus as claimed in any one of claims 21 to 26, wherein said status data and said N-dimensional array of data elements are stored together in an N-dimensional data array.

28. Apparatus as claimed in any one of claims 26 and 27, wherein said status data for a data element is indicative of three or more different status values.

29. Apparatus as claimed in any one of claims 21 to 25, wherein said scoreboard memory stores said status data as a plurality of N-dimensional arrays of status data.

30. Apparatus as claimed in claim 22, wherein each -processor of said plurality of processors processes said data elements from said N-dimensional array of data elements as sequences of data elements following a processing track through said N-dimensional array of data elements.

31. Apparatus as claimed in claim 30, wherein said processing track extends in one dimension of said N-dimensional array of data elements and has a common position in other dimensions of said N-dimensional array of data elements.

32. Apparatus as claimed in claim 31, wherein said N-dimensional array of data elements is a two-dimensional array of data elements formed as rows and columns and processing of said data elements by a processor of said plurality of processors is performed in turn upon data elements within a row.

33. Apparatus as claimed in any one of claims 31 and 32, wherein different processors of said plurality of processors perform respective processing operations upon different ones of said sequences of data elements extending in one dimension.

34. Apparatus as claimed in any one of claims 30 to 33, wherein said scoreboard memory stores said status data as an indication of a position reached along said processing track in processing of respective ones of said sequences of data elements.

35. Apparatus as claimed in any one of claims 21 to 34, wherein said plurality of other data elements within said N-dimensional array of data elements having respective predetermined positions within said N-dimensional array of data elements relative to said given data element comprise one or more adjacent data elements within said N-dimensional array of data elements.

36. Apparatus as claimed in any one of claims 21 to 35, wherein said processing operations performed upon said N-dimensional array of data elements comprises decoding operations and decoding said given data element is dependent upon a result of decoding one or more other data elements within said N-dimensional array of data elements having said predetermined positions within said N-dimensional array of data elements relative to said given data element.

37. Apparatus as claimed in claim 22, wherein said plurality of processors perform a common processing operation in parallel upon different data elements of said N-dimensional array of data elements.

38. Apparatus as claimed in any one of claims 21 to 37, wherein said data elements are one of
macroblocks of video data
macroblocks of image data and
blocks of three dimensional image data.

39. Apparatus as claimed in claim 22, wherein only a respective predetermined one of said plurality of processors is able to write status data corresponding to said given data element.

40. Apparatus as claimed in any one of claims 21 to 39, wherein said scoreboard memory does not store status data for portions of said N-dimensional array of data elements upon all of which a status change being tracked has been performed or upon none of which said status change being tracked has been performed.

41. Apparatus for processing data to perform a plurality parallel processing operations upon an N-dimensional array of data elements, where N is an integer greater than one, said apparatus comprising:
scoreboard memory means for storing status data indicative of a status of respective data elements within said N-dimensional array of data elements, a location of a data element within said N-dimensional array of data elements being indicative of a storage location of status data corresponding to said data element within said scoreboard memory; wherein
at least one of said plurality of processors means is arranged to check for a data hazard, in respect of processing to be performed upon a given data element within said N-dimensional array of data elements arising from a plurality of other data elements within said N-dimensional array of data elements having respective positions within said N-dimensional array of data elements relative to said given data element and upon which processing for said given data element is dependent, by reading status data for said plurality of other data elements within said N-dimensional array of data elements from said scoreboard memory means.
